(19) United States
(12) Patent Application Publication
(10) Pub. No.: US 2008/0245002 A1
(43) Pub. Date: Oct. 9, 2008

(54) Device and Method for Fixing Glass Windows to an Outer Wall Construction

(75) Inventors: Lambertus Willem van de Linde, Middelburg (NL); Marc Tony Zobec, New South Wales (AU)

Correspondence Address: THE WEBB LAW FIRM, P.C., 700 KOPPERS BUILDING, 436 SEVENTH AVENUE, PITTSBURGH, PA, 15219, US

(73) Assignee: PERMASTEELISA INTERNATIONAL B.V., Middelburg (NL)

(21) Appl. No.: 11/795,749

(22) PCT Filed: Jan. 18, 2006
(86) PCT No.: PCT/NL06/50014

§ 371 Date: Apr. 7, 2008

(30) Foreign Application Priority Data
Jan. 21, 2005 (NL) 1028082
Jan. 18, 2006 (NL) PCT/NL2006/050014

(51) Int. Cl. E06B 3/54

(52) U.S. Cl. 52/204.6; 52/745.15

(57) ABSTRACT

The invention relates to a profile for fixing a glass window comprising an inner pane and an outer pane to an outer wall construction, wherein the inner pane and the outer pane are separated by an insulating cavity, wherein the profile comprises a spacing profile which is adapted to extend between the inner pane and the outer pane of the window on the periphery of the window, a fixing profile which is adapted for connection to at least one of the panes of the window and to the outer wall construction, wherein the spacing profile and the fixing profile are combined into a unitary profile comprising a spacing part and a fixing part. This measure results in a considerable cost reduction, particularly in respect of the mounting, since only one profile need after all be placed.

The invention relates to a profile for fixing a glass window comprising an inner pane and an outer pane to an outer wall cons on, wherein the inner pane and the outer pane are separated by an insulating cavity, wherein the profile comprises a sa profile which is adapted to extend between the inner pane and the outer pane of the window on the periphery of the window, as well as a fixing profile which is adapted for connection to at least one of the panes of the window and to the outer wall construction.

Such a profile is known from EP-B-0 130 438. In the construction known from this document different profiles are applied, i.e. a spacing profile and a separate fixing profile. The application of separate profiles represents a considerable cost in such constructions, both in respect of the materials and the amount of work, since the profiles must each be mounted individually. The object of the invention is to provide such a profile, with which a considerable cost reduction can be realized.

This object is achieved with such a profile, wherein the spacing profile and the fixing profile are combined into a single unitary profile comprising a spacing part and a fixing part.

This measure results in a considerable cost reduction, particularly in respect of the mounting, since only one profile need after all be placed.

The present invention also relates to an assembly of such a profile with a glass window, wherein the spacing part of the profile extends between both panes of the window on the periphery of the window, and wherein the fixing part of the unitary profile extends at least partly beyond the periphery of the inner pane of the window.

The spacing part of the profile forms a connection between the outer pane and the inner pane of the window, as is also the case in prior art profiles. With the use of materials which conduct well thermally for the profile, this connection results in a thermal short-circuit or thermal bridge in the outer wall. This drawback occurs more noticeably in the profile according to the present invention because the composite profile is not only connected to the inner pane and the outer pane, but also to the outer wall construction.

In many cases this outer wall construction is manufactured from metal, i.e. of material which conducts well thermally, so that the adverse effect of the thermal bridge is increased when a composite profile of a material which conducts well thermally is used These problems are avoided when the profile is manufactured from a thermally insulating material such as plastic.

When the composite profile is manufactured from plastic it is also exposed to high loads, partly due to the generally heavy weight of the glass panes and the wind load exerted thereon. The difference in temperature between the parts of the composite profile sit on the inside and the outside of the outer wall likewise results in mechanical stresses, and thus to a heavy load. In order to be able to absorb these loads well, without adverse effects such as creep, the profile is manufactured according to a preferred embodiment of the invention from fibre-reinforced plastic.

In this field of the art, there is wide experience available in the use of aluminium as profile material. It is therefore attractive to make use of a plastic, the properties of which, such as the coefficient of thermal expansion, correspond with those of aluminium. Is has been found by the inventors that the plastic Acrylonitrile/styrene/acrylate polymer (ASA) has such properties, so that it is recommended to use this plastic. Other plastics are however in no way precluded.

The spacing part of the composite profile not only serves to maintain a space between the inner pane and the outer pane, but also as a wall for keeping the space between the panes moisture-tight. The preferably applied plastics are generally mis-permeable. It is therefore recommended that the spacing profile is provided with a thin metal layer on at least one of its surfaces extending transversely of the glass surface. It is hereby possible to obtain a moisture seal while main the thermally insulating properties of plastic. It is of course important here that the metal layer is thin so as to prevent thermal short-circuiting through the layer. The layer can be embodied as a glued-on layer of metal foil, but also as a vapour-deposited metal layer.

A further preferred embodiment provides the measure that the composite profile comprises a connecting strip which connects the spacing part and the fixing part of the composite profile to each other. A further thermal insulation is hereby obtained between the two profile parts.

According to yet another embodiment, the spacing part of the profile is provided with chamfered ribs on its side directed toward the fixing part. More surface area hereby becomes available on the glass for adhesion of the adhering mastic. The surface area for the sealing mastic is of course hereby decreased, but this has been found to be irrelevant.

The shape of the profile is such that it does not provide a form-locking connection between profile and glass. Use is preferably made of mastic or other adhesive mass which provides the mechanical connection between the profile and each of the glass panes. The profile is adapted for this purpose to form a cavity connecting to the outer pane and a cavity connecting to the inner pane. The cavities can then be formed with mastic or other adhesive material in order to form a connection between the panes and the profile. The invention therefore also relates to such an assembly wherein the profile is connected to the inner pane and to the outer pane by means of an adhesive, wherein the adhesive fills the hollow spaces between the profile, the inner pane and the outer pane. Butyl mastic is preferably used as adhesive mastic.

The fixing strip forms a closure of the cavity between the two profile parts and the inner pane. Because this cavity must be filled with an adhesive mastic, such as butyl mastic, it is important for this cavity to be accessible. According to a further preferred embodiment the fixing strip is provided for this purpose with openings.

The insulating cavity is filled with a dry gas such as dried air, carbon dioxide or an inert gas. In order to maintain the insulating function a good vapour-tight seal must be maintained between the environment and the cavity. For this purpose a further preferred embodiment provides the measure that a sealing layer is arranged between the spacing part of the profile and each of the panes. This layer can be formed by a mastic or by a strip of sealing material.

So as not to adversely affect the appearance of outer walls comprising several assemblies according to the invention, it is recommended that the inner pane has a smaller surface area than the outer pane; the outer pane then coves the profile so that the profile is not visible from the outside.

For some applications it is furthermore attractive when the outer pane protrudes further outward than the inner pane, and when the layer of mastic between the two parts is trimmed obliquely. The further protruding of the outer pane improves the above stated advantage, i.e. the invisibility of the profiles. Space is moreover each for fixing further profiles such as covering, decorative or protective profiles. The sloping direction of the mastic layer is also important, since a good adhesion to the glass is hereby ensured, while maximum space remains available.

During handling the assembly, for instance during transport between the location where the assembly is manufactured and the construction site, it is attractive that the outer surface of the profile, which during fitting is situated on the inside, lies in the same plane as the outer surface of the inner pane, which during fitting is situated on the inside. This measure moreover provides the option during manufacturing of this assembly of placing the components in a normal press, which does not need to be modified.

To improve the mounting and fixing of the assemblies, it is attractive when the fixing part of the profile comprises a strip extending from the side of the fixing part of the profile situated opposite the inner pane, wherein the strip is placed such that the fixing means connecting the strip to the structure can be accessed using an operating element extending outside the outer edge of the outer pane.

During the construction of an outer wall using glass windows and profiles according to the invention the profiles must be accessible during fitting. The consequence hereof is that the glass windows cannot be fitted connecting to each other, so that gaps remain between the windows. From thermal considerations it is also attractive to cover such gaps. For this purpose another preferred embodiment of the invention provides the measure that the spacing part of the composite profile is provided with engaging means for engaging a secondary profile. This secondary profile can then fulfil the sealing function of the gap. It is otherwise also possible to apply a secondary profile for other purposes.

The invention also relates to a method for arranging a glass window comprising an inner pane and an outer pane on an outer wall construction, wherein the method comprises the following steps of arranging the spacing part of the composite profile on the inner pane along its peripheral edge, wherein the fixing part of the profile protrudes beyond the peripheral edge of the inner pane, arranging the outer pane on the spacing part of the profile, arranging an adhesive in the space between the cavities of the profile and the panes, and fixing the profile to the outer wall construction.

Advantage is taken of the invention here due to the fact that only a single profile must be fitted.

The method furthermore provides a degree of freedom in that the sequence of operations provides a certain degree of freedom. It is recommended to assemble the assembly of the window wholly in the factory. The assembly is herein fixed to the outer wall after the adhesive is arranged in the spaces between the cavities of the profile and the panes. The window is then provided with the fixing part of the profile so that it can be readily mounted at the construction she. There is the advantage here of closing the window under conditioned circumstances, so that the space between the panes is controlled.

It is however also possible for the profile to be fixed to the outer wall construction after the spacing part of the profile is arranged on the inner pane and before the outer pane is arranged on the spacing part of the profile. The window is herein assembled wholly at the construction site.

The present invention will be elucidated hereinbelow with reference to the accompanying drawings, in which:

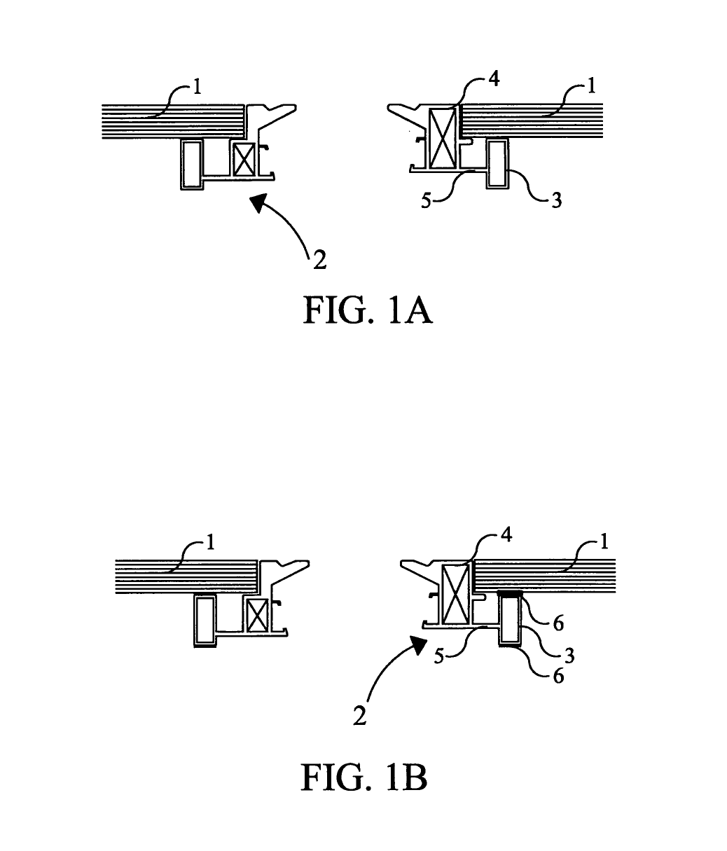

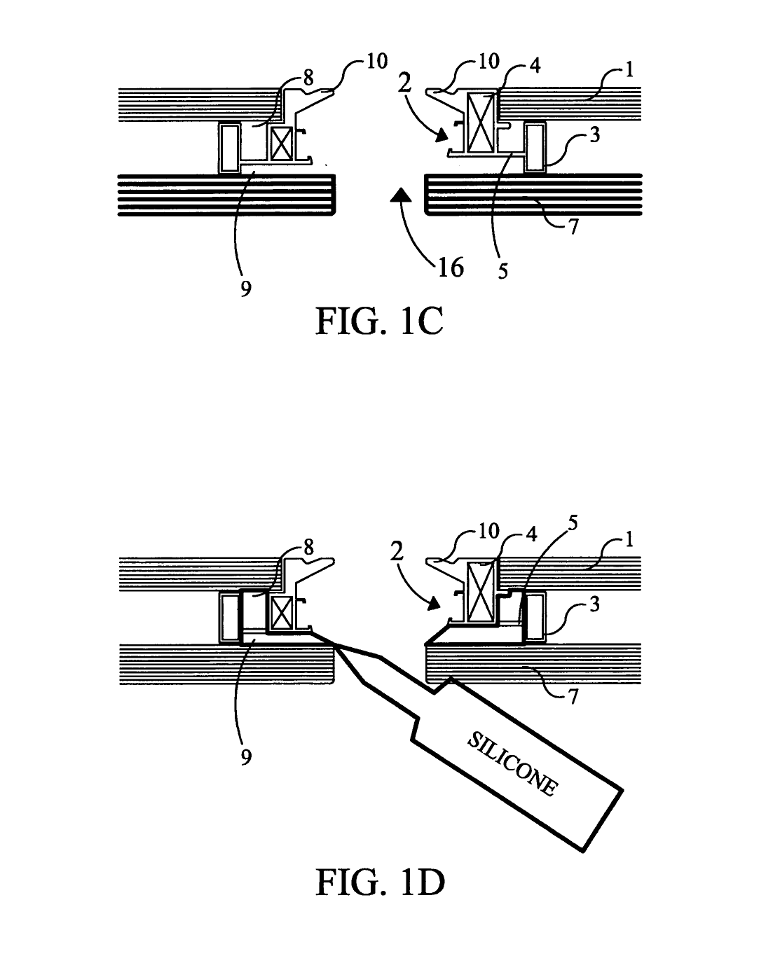

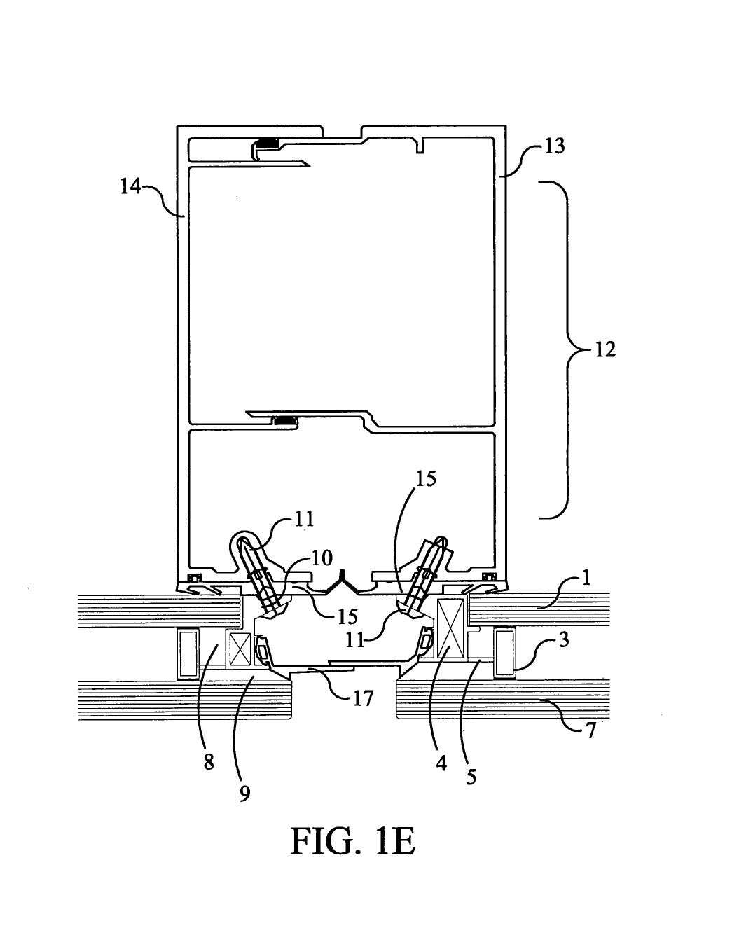

FIGS. 1A-1E are cross-sectional views of an assembly of a window with a profile according to the present embodiment, at diverse stages of the assembly;

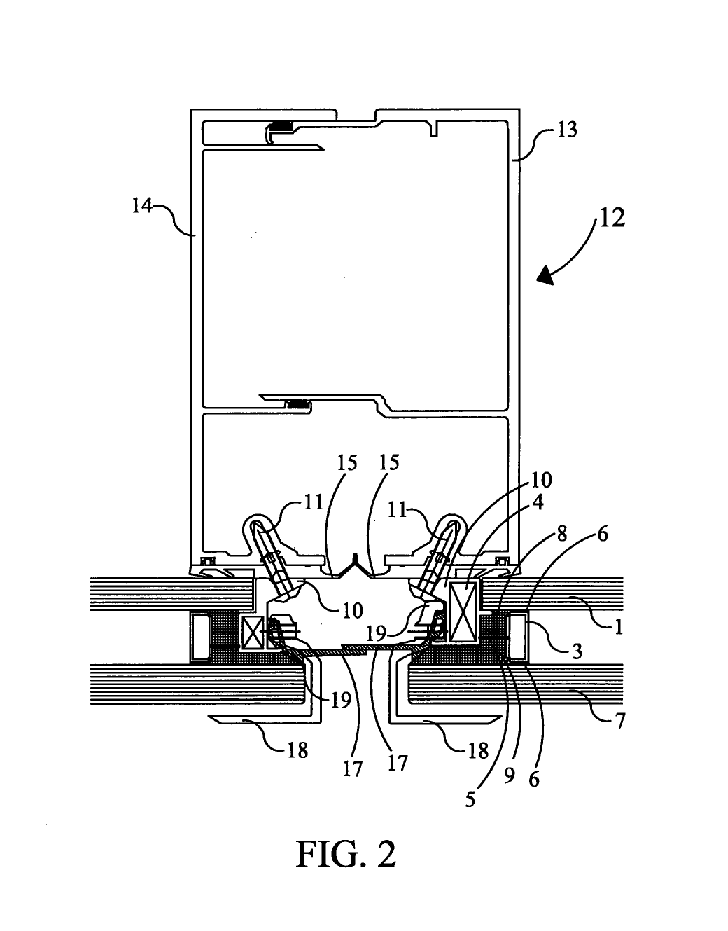

FIG. 2 is a view corresponding with FIG. 1E of another embodiment.

FIG. 1A shows an internal glass layer 1 which in the completed assembly forms the inner pane of the window for assembling. A composite profile designated in its entirety with 2 is placed against glass layer 1. The composite profile 2 comprises a spacing profile part 3 and a fixing profile part 4, which are connected by a connecting strip 5. Both the spacing part 3 of the profile and the fixing part 4 of the profile take a hollow form. They both have a rectangular cross-section. Although other materials, such as aluminium, are not precluded, profile 2 is preferably manufactured entirely from reinforced plastic.

One of the short side surfaces of spacing profile part 3 is placed against glass layer 1. Fixing part 4 of the profile is herein placed against the end edge of the glass layer. Because spacing part 3 must be sealing connected to the glass layer, a layer 6 of a sealing material such as butyl mastic is preferably arranged between glass layer 1 and spacing profile part 3. A solid sealing material can also be applied instead of mastic. The situation is hereby reached which is shown in FIG. 1B. Other measures can also be taken to maintain the vapour-tight seal between the cavity and the environment. Instead, or as additional measures, moisture-absorbing substances such as a dessicant can be placed in the cavity.

A second glass layer 7, which will function as outer pane, is then arranged on the thus obtained assembly. Use is preferably also made here of a layer of sealing material 6. It is pointed out here that the outer pane 7 of the assembled window has a larger surface area than inner pane 1. This is related to the fact that in the present embodiment the profile 2 is largely concealed from view by outer pane 7.

The thus formed assembly must of course be formed into a connected whole. In this embodiment use is made for this purpose of an adhesive mastic, such as silicone mastic or butyl mastic. Other adhesive mastic types, such as polysulphide mastic, can however also be used. This mastic is arranged in space 8 between inner pane 1, spacing part 3 of the profile, fixing part 4 of the profile and connecting strip 5 of the profile. A strong connection between said components is hereby obtained. The adhesive mastic is further arranged in the space 9 enclosed by outer pane 7 and all components 3, 4 and 5 of the profile. A good connection of these components to outer pane 7 is hereby established. The thus obtained situation is shown in FIG. 1D. It is noted here that the profiles according to the invention do not provide for a form-locking connection, so that a connection between the glass sheets and the profile is formed by means of adhesives.

This latter space 9 can be readily accessed, so that it can easily be filled with mastic. The first stated space 8 is however enclosed. In order to access this space 8, openings are arranged at regular distances in connecting strip 5, through which openings the silicone mastic can be arranged. Another adhesive material can of course be used instead of silicone mastic. After applying and curing of the silicone mastic a strong assembly is created which can be mounted on the desired outer wall.

For this purpose the assembly is arranged at the desired location on the outer wall and the assembly is fixed against the outer wall by making use of a rib 10 attached to the fixing part of the profile. In the present exemplary embodiment use is made of screws 11 for screwing rib 10 to the structure of the outer wall. It is of course possible to make use of other fastening means, such as glue or snap connections.

The above demonstrates the advantage of the invention; since only a single profile 2 is applied, the number of operations is greatly reduced compared to the prior art A good thermal insulation results because plastic is used as material for the profile.

In the present exemplary embodiment, the outer wall structure comprises a vertical girder 12. As shown in FIG. 1E, this vertical girder 12 is formed by two mutually connected aluminium profiles 13 and 14. The assembly of the two profiles 13 and 14 is herein covered on the outer wall side by two profiles 15. Screws 11 extend through ribs 10, profiles 15 and profiles 13 and 14.

For the purpose of accessing screws 11 there must be a gap 16 present between adjacent glass windows 1. To prevent the entry of rainwater and to improve the appearance of the outer wall, use is preferably made of an auxiliary profile 17 to cover the gap 16. Two separate auxiliary profiles 17 are applied in the present exemplary embodiment. They are each connected to the fixing part of profile 4 by means of a form-locking connection Auxiliary profile 17 is preferably manufactured from flexible material.

The construction according to the invention is further shown in FIG. 2 in the form of a perspective schematic view. All components, as well as their relative position, are shown in this drawing.

It will be apparent that diverse modifications can be made to the embodiment shown here without filling outside the scope of the invention. It is thus possible for instance to apply a window of more than two panes. The profile according to the invention can herein be adapted to form a connection between the inner pane and the middle pane, but it is likewise possible that the profile forms a connection between the inner pane and the outer pane. Separate provisions can then be arranged for positioning the middle pane and for scaling the spaces between the inner pane and the middle pane, and the middle pane and the outer pane.

In the embodiment shown in FIG. 2, the outer pane extends beyond the composite profile. Not only does this create space for the covering or auxiliary profiles 17 behind the outer pane, but also for decorative profiles 18, which are generally desirable from an architectural viewpoint. For this purpose the connecting part of the composite profile 4 is provided with a back 19 in which openings can be arranged for fixing the decorative profiles 18.

A profile 15 manufactured from flexible material is otherwise placed in this embodiment between vertical girder 12 and inner pane 1. Sealing is hereby achieved between inner pane 1 and vertical girder 12, but also to the space inside vertical girder 12.

It will be apparent that numerous variations can be made to the shown embodiment without departing from the invention.

1-21. (canceled)

22. A profile for fixing a glass window comprising an inner pane and an outer pane to an outer wall construction, wherein the inner pane and the outer pane are separated by an insulating cavity, wherein the profile comprises:
a spacing profile which is adapted to extend between the inner pane and the outer pane of the window on the periphery of the window;
a fixing profile which is adapted for connection to at least one of the panes of the window and to the outer wall construction,
wherein the spacing profile and the fixing profile are combined into a unitary profile comprising a spacing part and a fixing part.

23. The profile as claimed in claim 22, wherein the profile is manufactured from a thermally insulating material such as plastic.

24. The profile as claimed in claim 23, wherein the profile is manufactured from fibre-reinforced plastic.

25. The profile as claimed in claim 23, wherein the profile is manufactured from Acrylonitrile/styrene/acrylate polymer (ASA).

26. The profile as claimed in claim 23, wherein the spacing profile is provided with a thin metal layer on at least one of its surfaces extending transversely of the glass surface.

27. The profile as claimed in claim 22, wherein the composite profile comprises a connecting strip which connects the spacing part and the fixing part of the unitary profile to each other.

28. The profile as claimed in claim 22, wherein the unitary profile is adapted to form a cavity connecting to the outer pane and a cavity connecting to the inner pane.

29. The profile as claimed in claim 27, wherein the connecting strip is provided with openings.

30. The profile as claimed in claim 22, wherein the spacing part is provided with engaging means for engaging a secondary profile.

31. The profile as claimed in claim 22, wherein the spacing part of the profile is provided with chamfered ribs on its side directed toward the fixing part.

32. An assembly of a profile as claimed in claim 22, with a glass window, wherein the spacing part of the unitary profile extends between the inner pane and the outer pane of the window on the periphery of the window, and that the fixing part of the unitary profile extends at least partly beyond the periphery of the inner pane of the window.

33. The assembly as claimed in claim 32, wherein the profile is connected to the inner pane and to the outer pane by means of an adhesive, which adhesive fills hollow spaces between the profile, the inner pane and the outer pane.

34. The assembly as claimed in claim 32, wherein a sealing layer is arranged between the spacing part and the two panes.

35. The assembly as claimed in claim 32, wherein the inner pane of the window has a smaller surface area than the outer pane.

36. The assembly as claimed in claim 35, wherein the outer surface of the profile, which during fitting is situated on the inside, lies in the same plane as the outer surface of the inner pane, which during fitting is situated on the inside.

37. The assembly as claimed in claim 32, wherein the fixing part of the profile comprises a strip extending from the side of the fixing part of the profile situated opposite the inner pane, wherein the strip is placed such that the fixing means connecting the strip to the structure can be accessed using an operating element extending outside the outer edge of the outer pane.

38. The assembly as claimed in claim 32, wherein a covering profile is coupled to the fixing part of the profile.

39. The assembly as claimed in claim 32, wherein the profile on the outer edge of the assembly extends as far as that on the outer pane.

40. The assembly as claimed in claim 32, wherein the outer pane protrudes further outward than the inner pane, and that the layer of mastic between the two parts is trimmed obliquely.

41. A method for arranging a glass window comprising an inner pane and an outer pane on an outer wall construction, comprising the following steps:
arranging the spacing part of the composite profile on the inner pane along its peripheral edge, wherein the fixing part of the profile protrudes beyond the peripheral edge of the inner pane;
arranging the outer pane on the spacing part of the profile,
arranging an adhesive in the space between the cavities of the profile and the panes; and
fixing the profile to the outer wall construction.

42. The method as claimed in claim 41, wherein the assembly is fixed to the outer wall after the adhesive is arranged in the spaces between the cavities of the profile and the panes.
